(19) United States
(12) Patent Application Publication
(10) Pub. No.: US 2018/0108025 A1
(43) Pub. Date: Apr. 19, 2018

(54) SYSTEMS AND METHODS FOR SENTIMENT INSIGHT IN ELECTRONIC MEDIA POSTINGS

(71) Applicant: SAP SE, Walldorf (DE)

(72) Inventors: Nisheeth Agarwal, Lucknow (IN); Naresh Gupta Maddi, Bentonville, AR (US)

(21) Appl. No.: 15/297,444

(22) Filed: Oct. 19, 2016

(51) Int. Cl. G06Q 30/02; H04L 29/08; H04L 12/58

(52) U.S. Cl. CPC G06Q 30/0201; H04L 67/22; G06Q 50/01; H04L 51/32; H04L 51/16

(57) ABSTRACT

A method for obtaining sentiment in electronic media postings includes a media stream parser unit monitoring electronic media postings present on an electronic communication network, displaying a selected electronic media posting on a display device of a client computing device, receiving an indication from a pointing device connected to the client computing device of an entity identifier within content of the selected electronic media posting, analyzing the content of the electronic media posting to identify a sentiment expression in the content, a sentiment analysis unit applying ranking rules to determine a sentiment ranking for the sentiment expression, and providing the sentiment ranking to the display device upon receiving the indication. A system to implement the method and a non-transitory computer-readable medium are also disclosed.

### BACKGROUND

Electronic media postings can contain comments and/or mentions by users expressing their sentiment regarding businesses, competitors, vendors, suppliers, products, customer service representatives, etc. Electronic media postings can also be directed to political opinions, sporting activity results, weather reports, and any other content in which perception of an entity is expressed. An enterprise can utilize these sentiments to understand customer perception of the enterprise itself, or to understand the context (community activity, social issues, corporate responsibility, etc.) in which their customers view the enterprise.

Knowing the electronic media posting sentiments expressed on vendors can inform an enterprise of which vendors are perceived as providing superior (or inferior) quality goods/services. Analysis of the expressed electronic media sentiment can also inform the enterprise as to whether an individual is expressing satisfaction, happiness, annoyance, or anger regarding their interaction with the subject of the posting.

Analysis of the sentiment can be used to measure product launches, marketing campaigns, reaction to favorable/unfavorable news, etc. Knowledge of the sentiment can be used by the enterprise to tailor/modify marketing campaigns, and gain understanding of overall market trends themselves.

### BRIEF DESCRIPTION OF THE DRAWINGS

FIG. 1 depicts an exemplar electronic media posting containing an expression of sentiment;

FIG. 2 depicts a system for obtaining sentiment insight from electronic media posts in accordance with embodiments;

FIG. 3 depicts the exemplar electronic media posting of FIG. 1 annotated with information regarding the expressed sentiment in accordance with embodiments;

FIG. 4 depicts a process for obtaining sentiment insight from electronic media posts in accordance with embodiments; and

FIG. 5 depicts a process for retrieving and displaying sentiment insight from captured electronic media posts in accordance with embodiments.

### DETAILED DESCRIPTION

In accordance with embodiments, systems and methods can provide insight into sentiment being expressed in electronic media postings for enterprises and/or other entities. Electronic media postings can be parsed for trigger keywords identifying the entity. Analysis of the postings containing the enterprise identifying trigger keywords can then be analyzed to obtain a sentiment ranking (e.g., highly favored, favored, neutral, disfavored, highly disfavored) on the entity. Embodiments are not so limited and other sentiment rankings can be assigned, along with differing degrees of customizable sentiment granularities. In accordance with embodiments, the sentiment information can be available in about real-time and online for display with the electronic media posting on a user display device. In accordance with embodiments, the displayed sentiment information can provide insight into the sentiment expressed in a currently displayed posting, along with sentiment insight from previous electronic media postings containing sentiment expressions regarding the same entity. In some implementations embodying systems and methods can be incorporated into, and/or implemented by, a sentiment analysis framework tool integrated in a cloud-based enterprise social collaboration software package—for instance, as provided by SAP Jam Collaboration.

An electronic media posting can be any type of digital information that is associated with a user identifier and is made available to other users. For example, an electronic media posting can be a textual comment, product/enterprise review, news article, advertisement, financial analysis, etc. that is posted to an electronic media platforms. The electronic media posting can be accessible to a mass audience to any user of the electronic media platform having no prior association to the posting user, or available to a limited number of users having a pre-association with the posting user (e.g., a list of friends, followers, contacts, etc.).

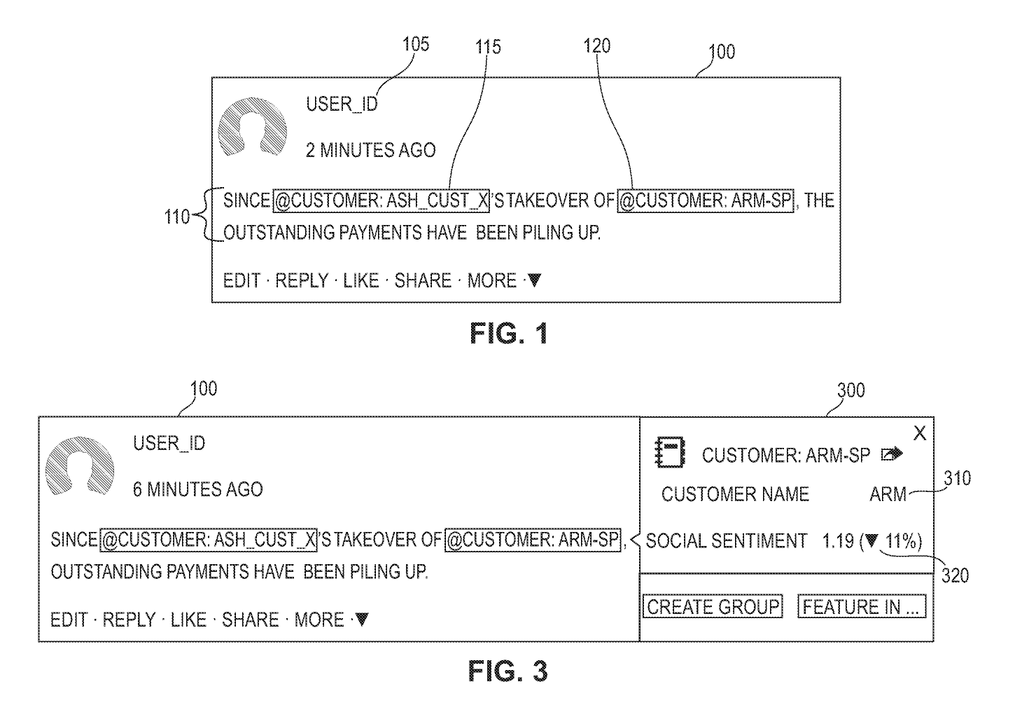

FIG. 1 depicts exemplar electronic media posting 100 containing an expression of sentiment. This exemplar could be posted on a number of different electronic media platforms. The electronic media posting can include user identification 105 and content 110. The content includes identifying terms 115, 120 for two entities (i.e., @Customer: ASH_CUST_X and @Customer: ARM-SP). The subject matter of content 110 expresses the posting user's sentiment regarding the promptness with which entity 120 @Customer: ARM-SP has been paying its bills since being taken over by entity 115 @Customer: ASH_CUST_X.

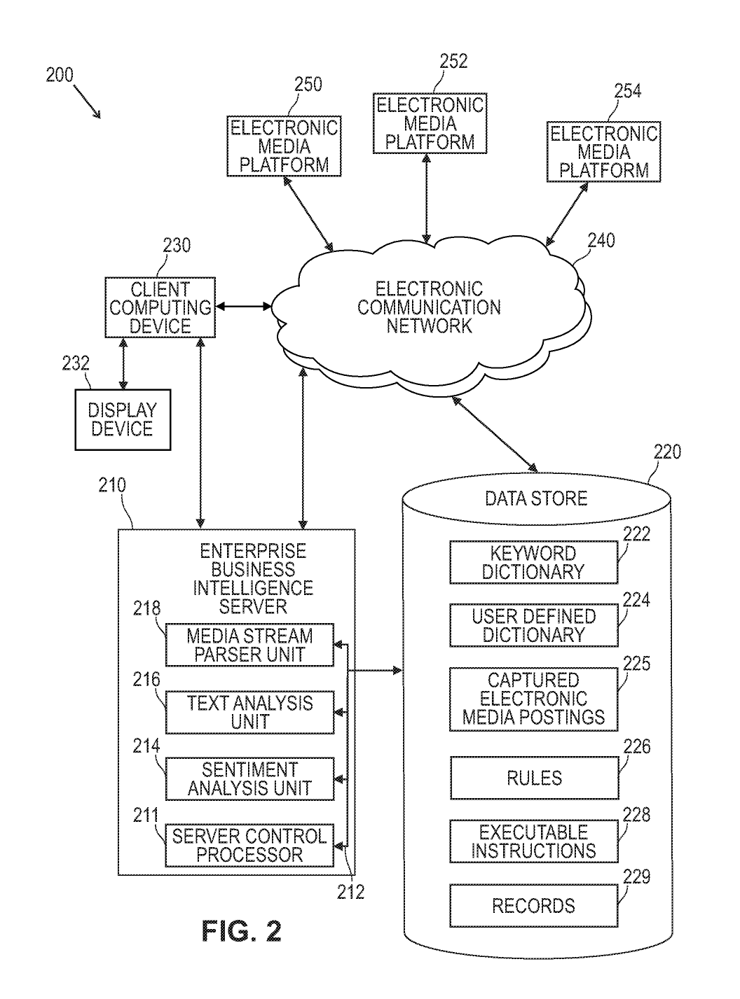

FIG. 2 depicts system 200 for obtaining sentiment insight from electronic media postings in accordance with embodiments. System 200 includes one or more electronic media platform(s) 250, 252, 254. A non-exhaustive list of electronic media platforms includes social media platforms (e.g., Facebook, Instagram, LinkedIn, Google+, Twitter, Snapchat, Yelp, and others), product review platforms (Yelp, CNET, Amazon, Yahoo, Google, etc.), news outlets (CNN, NY Times, BBC, etc.), financial sites (CNBC, Motley Fool, Kiplinger, Morningstar, etc.), and others. An electronic media platform can be a web-based technology which provides users with the ability to share expressive communication. These communications can be referred to as “posts,” “postings,” “tweets,” “messages,” etc.

System 200 can include Enterprise Business Intelligence Server 210, which is in communication with the electronic media platforms and other components over electronic communication network 240. Enterprise Business Intelligence Server 210 can be in direct communication with data store 220 and client computing device 230. Additionally, the server can communicate with the data store and the client computing device over the electronic communication network.

Client computing device 230 can be a personal computer, terminal, thin client, mobile device (tablet, smart phone, e-reader), laptop, netbook, or any computing device capable of communication across electronic communication network 240 to receive and/or access data and display the data on display 232. Display 232 can include a graphical display video processor, and be configured to receive input via a pointing device, or touch screen interface.

Electronic communication network 240 can be, can comprise, or can be part of, a private internet protocol (IP) network, the Internet, an integrated services digital network (ISDN), frame relay connections, a modem connected to a phone line, a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding, and/or any other suitable communication means. It should be recognized that techniques and systems disclosed herein are not limited by the nature of network 240.

Enterprise Business Intelligence Server 210 can include server control processor 211 running computer executable instructions 228. The executable instructions can be stored in data store 220, in a memory unit connected to server 210, and/or accessible from an external memory unit over electronic communication network 240. The server control processor may be a processing unit, a field programmable gate array, discrete analog circuitry, digital circuitry, an application specific integrated circuit, a digital signal processor, a reduced instruction set computer processor, etc.

The components of Enterprise Business Intelligence Server 210 can be in communication with the server control processor over data/control bus 212. These components can include media stream parser unit 218, text analysis unit 216, and sentiment analysis unit 214. Data store 220 can be a repository for data and executable instructions accessible by the server control processor. Retained within the data store can be, for example, keyword dictionary 222, user-defined dictionary 224, captured electronic media postings 225, and rules 226.

Media stream parser unit 218 can monitor electronic media postings on electronic media platform(s) 250, 252, 254. The media stream parser unit can access a list of keywords in keyword dictionary 222. The list of keywords can include entity identifiers, for example an enterprise name, personnel names (e.g., CEO, President, sales representatives, engineers, service representatives, and others), product names, and/or identifiers, etc. These keywords are used by the media stream parser unit in conjunction with rules 226 to determine if any of the keywords are present in an electronic media posting.

In accordance with embodiments, if the keyword is present in the posting, the electronic media posting can be displayed in an interactive user interface on display device 232. In some implementations, the electronic media posting can be stored in captured electronic media postings 225. In some implementations the rules can provide other conditions that could be met (independently or in conjunction with the keyword) to capture the electronic media posting. The media stream parser unit can continuously monitor electronic media postings, or can perform the monitor activity at some predetermined, selectable interval. Additionally, one or more of the electronic media platforms can be selectively targeted for monitoring.

In accordance with some embodiments, user defined dictionary 224 can include customized keywords provided by a user. These customized keywords can represent nicknames for the enterprise, product identifiers (e.g., product name, model number, stock keeping units (SKUs), etc.). The media stream parser unit can apply relevant keywords from the user-defined dictionary when monitoring the electronic media postings.

Text analysis unit 216 accesses captured electronic media postings stored in captured electronic media postings 225 repository. The text analysis unit can analyze the content of the electronic media posting to identify the user that generated the posting, the entity being discussed (e.g., the enterprise, personnel, product, etc.), and/or also identify sentiment being expressed within the positing. Text analysis unit 216 can access rules in rules repository 226, along with both keyword dictionary 222 and user-defined dictionary 224 to perform its content analysis. The results of this content analysis can be stored as records 229 in data store 220.

In accordance with embodiments, monitoring by media stream parser unit 218 and the subsequent content analysis by text analysis unit 216 is performed interactively, on-line in about real-time on the electronic media posting displayed on display device 232. The interactive parsing and content analysis can be performed when an indication is received from a pointing device, or activation of a touch screen, hovering over the electronic media posting being displayed. The interactive parsing and content analysis can identify an enterprise, its personnel, and/or its products or services mentioned in the electronic media posting.

In some implementations, the parsing and content analysis can be performed on an electronic media posting stored in captured electronic media postings 225, after the electronic media posting is retrieved and displayed on the display device.

Sentiment analysis unit 214 can include an ontology that defines positive and negative sentiment terms, phrases, and/or emotional expressions. Terms in the ontology can be refined on an ongoing basis. This refinement can be performed by heuristic approaches, such as machine learning and/or artificial intelligence implementations.

In accordance with embodiments, sentiment analysis unit 214 can apply ranking rules stored in rules 226 to sentiment data from records 229 to determine a ranking of the sentiment expressed in the associated electronic media posting. The ranking can be classified in discrete categories that bin sentiments across a spectrum from highly unfavorable to highly favorable, or in an analog fashion with numeric rankings (e.g., negative to positive integers (with 0 be neutral), 0 to 100, etc.). In accordance with implementations, the sentiment rankings can be assigned textual descriptors by binning sentiments across the spectrum into ranges.

FIG. 3 depicts exemplar electronic media posting 100 annotated with information block 300 containing details of the expressed sentiment in accordance with embodiments. Information block 300 can contain entity identification 310 on which the expressed sentiment is attributed. Also within the information block can be the sentiment rank 320, which can contain a numeric ranking (e.g., 1.19), along with a trend indicator (e.g., down 11.9%). In accordance with embodiments, the trend indicator of information block 300 can include sentiment information expressed in the currently displayed posting, along with sentiment insight from previous electronic media postings containing sentiment expressions regarding the same entity.

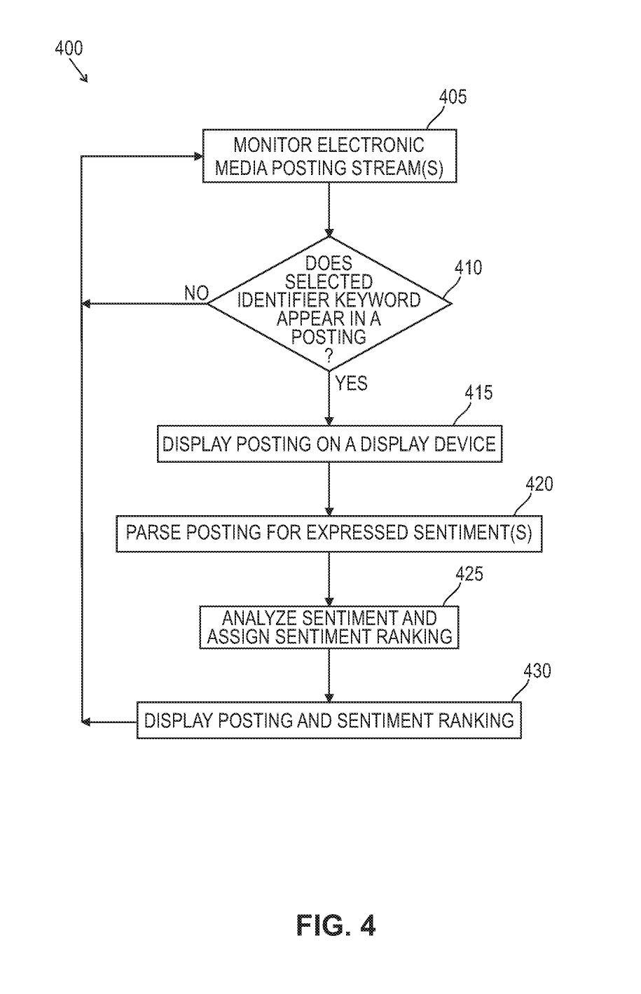

FIG. 4 depicts process 400 for obtaining sentiment insight from electronic media posts in accordance with embodiments. Electronic media platform streams are monitored, step 405, for electronic media postings. The electronic media streams can be monitored by media stream parser unit 218, which can access keyword dictionary 222, and/or user-defined dictionary 224 to obtain keywords. In accordance with embodiments, a user can define one or more filter queries that identify the entity, or entities, to be sought by the media stream parser unit.

If a keyword appears, step 410, in the monitored electronic media stream the process continues to step 415. If the keyword does not appear, monitoring of the electronic media stream continues. In accordance with embodiments, the electronic media stream can be continuously monitored, or monitored periodically at a predetermined (and selectable) interval. In some implementations, the monitoring can be selected as continuous for one set of keywords, and at periodic intervals for another set of keywords.

If the decision indicates that a keyword is present in a particular electronic media posting, that posting can be displayed, step 415, in an interactive user interface on the display device. In some implementations, the electronic media posting can be stored in data store 220. Along with the electronic media posting, other items, and/or metadata, associated with the particular posting can be stored—for example, the user identification of the posting entity, the entity or entities identified in the posting, the origin of the post, the time and date of the posting, etc.

Whether the origin of the displayed electronic media posting is from an about real-time media stream available through electronic communication network 240, or originated by retrieval from captured media postings 225, when an indication is received from a user (e.g., from a pointing device hovering on the displayed posting, activation of a touch screen location corresponding to a region of the posting, etc.), the electronic media posting is parsed, step 420, to identify the expressed sentiment(s) within the posting. Text analysis unit 216 can access the posting and analyze its content utilizing both keyword dictionary 222 and user-defined dictionary 224. Results of the parsing can be stored in records 229.

The identified sentiment expression(s) can be analyzed, step 425, by sentiment analysis unit 214 applying ranking rules stored in rules 226 to the sentiment expressions stored in record 229. This analysis can produce a sentiment ranking that is assigned to the electronic media posting. The sentiment ranking can be stored in the records 229 associated with the electronic media posting. In accordance with embodiments, the sentiment ranking for a particular entity can be cumulatively tracked to develop an indicator of ranking changes over a time period for the entity.

The electronic media posting (e.g., electronic media posting 100), and information block 300 can be displayed, step 430, on display 232 of client computing device 230. In accordance with embodiments, the electronic media posting can be displayed alone. When a pointing device hovers over the electronic media posting, or by activation of a touch screen, the information block can be displayed. A sentiment score for the particular subject content of the posting, an overall sentiment score for the entity, and/or a sentiment ranking trend indicator can be displayed in information block 300.

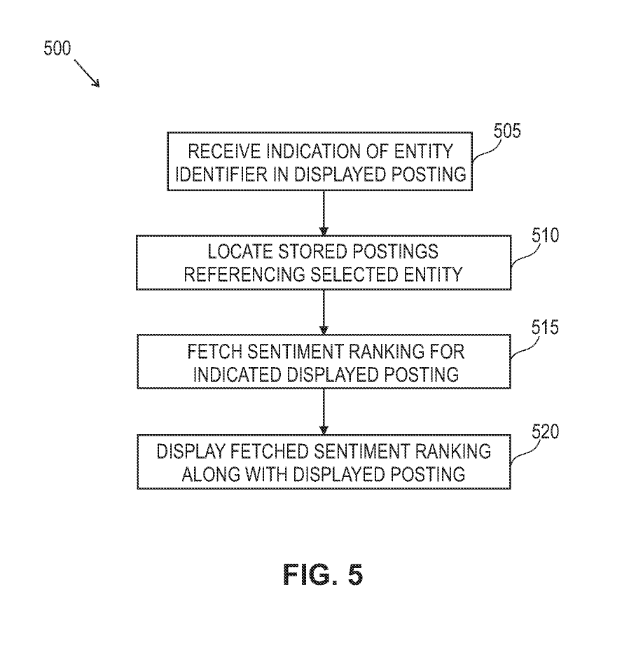

FIG. 5 depicts process 500 for retrieving and displaying sentiment insight from content of electronic media posts in accordance with embodiments. System 100 can receive an indication, step 505, of an entity identified in an electronic media posts displayed on a display device. The displayed electronic media post can be an about real-time, on-line posting available on electronic media platform 250, 252, 254. In some implementations, the displayed electronic media post can be retrieved from captured electronic media postings 225 in a data store. The user can identify the selected entity via client computing device 230 by either hovering a pointing device over entity identifier 115 in the displayed posting, or by activation of a touch screen at that location. The entity identifier can be in the keyword dictionary, or can be entered into the user-defined dictionary.

The data store and records can be searched to locate, step 510, stored electronic media postings that contain references to the selected entity. A sentiment ranking can be fetched, step 515, associated with the indicated entity. Along with the sentiment ranking, further information associated with the electronic media posting, the selected entity, the posting entity, or other items can also be fetched from the data store or records. The fetched information can be displayed, step 520, along with the displayed posting. The fetched information can be presented in information block 300, or in another graphical representation—e.g., trend lines over time indicating changes in an entity sentiment rank. In accordance with embodiments, the displayed electronic media posting can be analyzed for its sentiment content. The information block can include an updated sentiment ranking that includes the ranking for the current displayed posting.

In accordance with embodiments, information stored in data store 230 and records 239 can be used to create a listing correlating the posting entity identification (i.e., user identification 105) with sentiment expression rankings in one or more of the captured electronic media postings created by that user. This listing can be used to determine if a posting entity has a bias in their expressed sentiment for an entity.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as a method for monitoring electronic media postings to identify and rank content that expresses sentiment regarding selected entities, as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A method for obtaining sentiment insight in electronic media postings, the method comprising:
monitoring electronic media postings by a media stream parser unit, the electronic media postings present on an electronic communication network;
displaying a selected electronic media posting on a display device of a client computing device;
receiving an indication from a pointing device connected to the client computing device of an entity identifier within content of the selected electronic media posting;
analyzing the content of the electronic media posting to identify an expression of a sentiment in the content;
applying ranking rules by a sentiment analysis unit to determine a sentiment ranking of the identified expression of sentiment; and
providing the sentiment ranking to the display device upon receiving the indication.

2. The method of claim 1, including:
accessing one or more entity identifiers in at least one of a keyword dictionary and a user-defined dictionary; and
applying a first set of rules in conjunction with the one or more entity identifiers to determine the selected electronic media postings.

3. The method of claim 1, including monitoring the electronic media postings one of continuously or at a selectable interval.

4. The method of claim 1, including accessing a second set of rules and at least one of a keyword dictionary and a user-defined dictionary to obtain terms for analyzing the electronic media posting content.

5. The method of claim 1, including defining positive sentiment terms, neutral sentiment terms, and negative sentiment terms in an ontology used in applying the ranking rules.

6. The method of claim 5, including applying heuristic approaches to refine the positive sentiment terms, the neutral sentiment terms, and the negative sentiment terms.

7. The method of claim 1, the received indication being one of a pointing device hovering over the content and a touch screen activation over the content.

8. The method of claim 1, including providing the sentiment ranking as an information block containing one of the entity identifier, the sentiment ranking, and a trend analysis of the sentiment ranking.

9. A system for obtaining sentiment in electronic media postings, the system comprising:
a server including a control processor, the server connected to an electronic communication network;
a media stream parser unit under instruction from the control processor configured to monitor electronic media postings present on the electronic communication network, the media stream parser unit configured to at least one display selected electronic media postings on a display device connected to a client computing device and store selected electronic media postings in a data store;
a text analysis unit under instruction from the control processor configured to access the selected electronic media posting, and to analyze a content of the electronic media posting to identify an expression of a sentiment;
a sentiment analysis unit under instruction from the control processor configured to determine a sentiment ranking of the identified expression of sentiment by applying ranking rules; and
the server configured to provide the sentiment ranking to the display device upon receiving an indication from a pointing device connected to the client computing device.

10. The system of claim 9, the media stream parser unit configured to access one or more entity identifiers in at least one of a keyword dictionary and a user-defined dictionary.

11. The system of claim 10, the media stream parser unit configured to apply a first set of rules stored in the data store in conjunction with the one or more entity identifiers to determine the selected electronic media postings.

12. The system of claim 9, the media stream parser unit configured to monitor the electronic media postings one of continuously or at a selectable interval.

13. The system of claim 9, the text analysis unit configured to access a second set of rules and at least one of a keyword dictionary and a user-defined dictionary to analyze the electronic media posting content.

14. The system of claim 9, the sentiment analysis unit including an ontology containing terms that define positive sentiment terms, neutral sentiment terms, and negative sentiment terms.

15. The system of claim 14, the ontology configured to refine the terms by applying heuristic approaches.

16. The system of claim 9, the indication including one of a pointing device hovering over the content and a touch screen activation over the content.

17. The system of claim 9, the sentiment ranking provided for display as an information block containing one of the entity identifier, the sentiment ranking, and a trend analysis of the sentiment ranking.

18. A non-transitory computer-readable medium having stored thereon instructions which when executed by a control processor cause the control processor to perform a method for obtaining sentiment in electronic media postings, the method comprising:
monitoring electronic media postings present on an electronic communication network;
displaying a selected electronic media posting on a display device of a client computing device;
receiving an indication from a pointing device connected to the client computing device of an entity identifier within content of the selected electronic media posting;
analyzing the content of the electronic media posting to identify an expression of a sentiment in the content;
applying ranking rules to determine a sentiment ranking of the identified expression of sentiment; and
providing the sentiment ranking to the display device upon receiving the indication.

19. The non-transitory computer-readable medium of claim 18, the instructions further configured to cause the control processor to perform the steps of:
accessing one or more entity identifiers in at least one of a keyword dictionary and a user-defined dictionary;
applying a first set of rules in conjunction with the one or more entity identifiers to determine the selected electronic media postings;
accessing a second set of rules and at least one of a keyword dictionary and a user-defined dictionary to obtain terms for analyzing the electronic media posting content; and
providing the sentiment ranking as an information block containing one of the entity identifier, the sentiment ranking, and a trend analysis of the sentiment ranking.

20. The non-transitory computer-readable medium of claim 18, the instructions further configured to cause the control processor to perform the steps of:
defining positive sentiment terms, neutral sentiment terms, and negative sentiment terms in an ontology used in applying the ranking rules; and
applying heuristic approaches to refine the positive sentiment terms, the neutral sentiment terms, and the negative sentiment terms.
